(19) United States
(12) Patent Application Publication
(10) Pub. No.: US 2025/0113798 A1
(43) Pub. Date: Apr. 10, 2025

(54) PET TOILET

(71) Applicant: Shanshan ZHANG, Shenzhen (CN)

(72) Inventor: Shanshan ZHANG, Shenzhen (CN)

(21) Appl. No.: 18/484,220

(22) Filed: Oct. 10, 2023

(51) Int. Cl. A01K 1/01

(52) U.S. Cl. CPC A01K 1/0114

(57) ABSTRACT

The present disclosure provides a pet toilet including a base and a rotary drum rotatably arranged on the base. The base is provided with a waste chamber for collecting waste and a first opening communicated with the waste chamber, the base is movably provided with a baffle plate at the first opening; at an initial position, the baffle plate covers the first opening; and in a rotating process of the rotary drum, the baffle plate moves with the rotary drum to open the first opening.

### TECHNICAL FIELD

The present disclosure relates to the technical field of pet supplies, and in particular, to a pet toilet.

### BACKGROUND

In order to facilitate the handling of waste caked by feces made by a cat and litter, intelligent litter boxes have emerged on the market. The intelligent litter box includes a base and a rotary drum. The base is provided with a bedpan for collecting waste, and a passage is formed in a position, corresponding to the bedpan, of the base. The rotary drum can rotate relative to the base. Furthermore, when the rotary drum rotates, a filter gauze can sifter cat litter and waste, so that the waste would fall into the bedpan through an opening on the rotary drum and the passage on the base, which achieves cleaning of the waste on the cat litter. However, at present, there is a large gap between the existing rotary drum and the base, so that the odor generated by the waste will be diffused into the air from the gap between the rotary drum and the base over time, which reduces the user experience.

### SUMMARY

The present disclosure mainly aims to provide a pet toilet, so as to solve the problem that the odor of waste in a bedpan is easily diffused into the air through a gap between a base and a rotary drum of an existing intelligent litter box.

In order to solve the technical problem, the technical scheme provided by the present disclosure is as follows.

A pet toilet includes a base and a rotary drum rotatably arranged on the base. The base is provided with a waste chamber for collecting waste and a first opening communicated with the waste chamber; the base is movably provided with a baffle plate at the first opening; at an initial position, the baffle plate covers the first opening; and in a rotating process of the rotary drum, the baffle plate moves with the rotary drum to open the first opening.

Further, the rotary drum is provided with a number of push members; at least three first rollers are rotatably arranged at a bottom of the baffle plate; and in the rotating process of the rotary drum, the push members push the baffle plate to move to open the first opening.

Further, an upper surface of the base is downwards sunken to form an avoiding slot; a bottom surface of the avoiding slot is a sunken cambered surface; the first opening is located in the avoiding slot; at the initial position, at least part of the baffle plate is arranged in the avoiding slot; and the baffle plate is of a structure with a downwards sunken middle portion.

Further, the bottom surface of the avoiding slot is provided with concave grooves at two ends of the first opening to store the first rollers, and the first rollers are arranged in the concave grooves when the baffle plate is at the initial position.

Further, a side wall of each concave groove is a first guide surface.

Further, a size of the baffle plate is greater than a size of the first opening.

Further, a width of the bottom surface of the avoiding slot extending on one or two sides of the first opening is greater than a moving distance of the baffle plate.

Further, a quantity of the first rollers is four, and the four first rollers are divided into two groups located at a front end and a rear end of the first opening.

Further, the rotary drum is provided with a second opening communicated with an interior of the rotary drum, and the push members are located on a side edge of the second opening.

Further, a quantity of the push members is plural, and at least two of the push members are located on two sides of the second opening.

Further, the rotary drum is internally provided with an integral partition plate located next to the second opening and a sifter located on one side, away from the second opening, of the integral partition plate; the sifter and the integral partition plate divide the interior of the rotary drum into a storage tank for storing pet litter and a pet chamber; when the rotary drum rotates, pet litter and waste are sifted through the sifter; and when the rotary drum continues to rotate, the waste rotates along the integral partition plate to the second opening for discharging. Further, the integral partition plate and the rotary drum are integrally molded.

Further, the rotary drum includes a first housing and a second housing connected to the first housing; the integral partition plate includes a first partition plate integrally molded with the first housing, and a second partition plate integrally molded with the second housing; and the first partition plate and the second partition plate form the integral partition plate when the first housing is connected to the second housing.

Further, the integral partition plate includes a cambered surface section located next to the sifter, and a guide section; a side surface, away from the storage tank, of the cambered surface section is a cambered surface protruding relative to a side wall of a bin body; and the guide section extends from the cambered surface section to the second opening to guide the waste to the second opening when the rotary drum rotates.

Further, two end surfaces of the sifter protrude outwards to form first insertion blocks; first insertion slots are formed in positions, corresponding to the first insertion blocks, on an inner side wall of the rotary drum; the first insertion blocks are arranged in the first insertion slots; the inner side wall of the rotary drum protrudes on one side, away from the integral partition plate, of the sifter to form a first limiting block for limiting the sifter.

Further, a rear end surface of the rotary drum is provided with a first gear; first supporting slots matched with the rotary drum are formed in a front side wall and a rear side wall of the avoiding slot; the base is provided with a motor and a second gear connected with the motor; the second gear is at least partially located in the first supporting slot at the rear end; the second gear is engaged with the first gear; when the motor drives the second gear to rotate, the rotary drum rotates through the first gear; and a bottom surface of the first supporting slot located on the front side wall of the avoiding slot is rotatably provided with a plurality of second rollers spaced apart from each other.

Further, the base is provided with a support plate; the support plate is located behind the first supporting slot located at the rear end; a second supporting slot is formed in the support plate; a bottom surface of the second supporting slot is rotatably provided with a plurality of third rollers spaced apart from each other; a convex column is arranged on the rear end surface of the rotary drum; the convex column is located in the middle of the first gear; an annular groove is formed in an outer side wall of the convex column; and some of the third rollers are arranged in the annular groove.

Further, a bottom of the base is detachably provided with a collection basin, and the waste chamber is located on the collection basin.

Further, two sides of a top of the collection basin outwards extend to form second insertion blocks; sliding chutes used in conjunction with the second insertion blocks are formed in the bottom of the base; and the second insertion blocks are arranged in the sliding chutes.

Further, the bottom of the base is further provided with a plurality of support legs located on a circumferential side of the collection basin; and a bottom surface of the collection basin is located above bottom surfaces of the support legs.

Compared with the prior art, the present disclosure has the beneficial effects below: In the present disclosure, the baffle plate is arranged at the first opening communicated with the waste chamber, and when the rotary drum is at the initial position, the baffle plate covers the first opening. In this way, the odor of the waste in the waste chamber can be effectively prevented from being diffused into the air from the first opening, so as to solve the problem that the odor of waste in a bedpan is easily diffused into the air through a gap between the base and the rotary drum of an existing intelligent litter box. The air quality of pet keeping is improved. Furthermore, when the rotary drum rotates to discharge the waste, the baffle plate can be driven to move to open the first opening without affecting the waste discharging of the rotary drum.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a three-dimensional diagram of the present disclosure;

FIG. 2 is a schematic diagram showing that a baffle plate covers a first opening according to the present disclosure;

FIG. 3 is a schematic diagram of a base without a baffle plate according to the present disclosure;

FIG. 4 is a three-dimensional diagram of a rotary drum of the present disclosure;

FIG. 5 is a schematic diagram of a rotary drum without a second housing according to the present disclosure;

FIG. 6 is a structural diagram of a second housing according to the present disclosure;

FIG. 7 is a partially exploded diagram of a base of the present disclosure; and

FIG. 8 is an exploded diagram of a base and a collection basin of the present disclosure.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

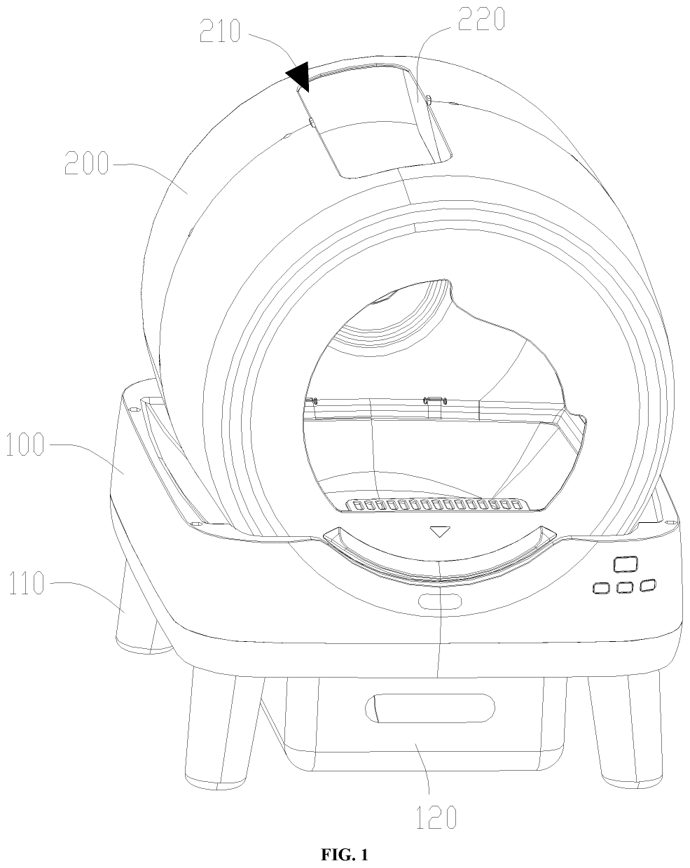

Referring to FIG. 1 to FIG. 8, a pet toilet in the embodiments of the present disclosure is shown.

Referring to FIG. 1 to FIG. 3, the pet toilet includes a base 100, and a rotary drum 200 rotatably arranged on the base 100. The base 100 is provided with a waste chamber 121 for collecting waste and a first opening 140 communicated with the waste chamber 121. The base 100 is movably provided with a baffle plate 130 at the first opening 140. At an initial position, the baffle plate 130 covers the first opening 140. In a rotating process of the rotary drum 200, the baffle plate 130 moves with the rotary drum 200 to open the first opening 140.

In this embodiment, the baffle plate 130 is arranged at the first opening 140 communicated with the waste chamber 121, and when the rotary drum 200 is at the initial position, the baffle plate 130 covers the first opening 140. In this way, the odor of the waste in the waste chamber 121 can be effectively prevented from being diffused into the air from the first opening 140, so as to solve the problem that the odor of waste in a bedpan is easily diffused into the air through a gap between the base 100 and the rotary drum 200 of an existing intelligent litter box. The air quality of pet keeping is improved. Furthermore, when the rotary drum 200 rotates to discharge the waste, the baffle plate 130 can be driven to move to open the first opening 140 without affecting the waste discharging of the rotary drum 200.

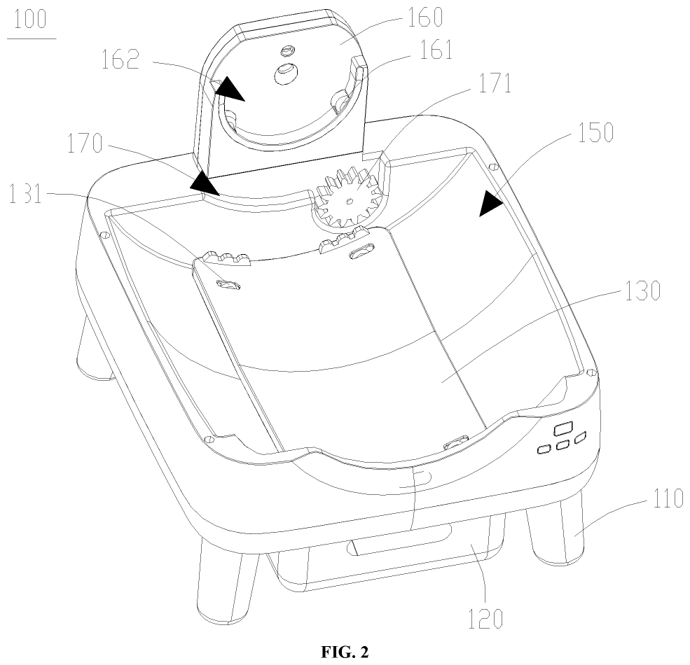

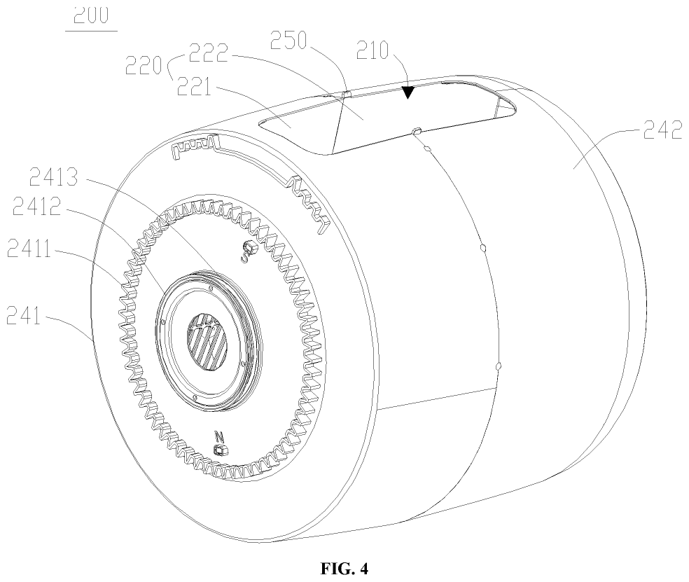

Specifically, with reference to FIG. 2 and FIG. 4, in the above embodiment, the rotary drum 200 is provided with a number of push members 250. The push members 250 push the baffle plate 130 to move in the rotating process of the rotary drum 200, so as to open the first opening 140 to allow the waste discharged by the rotary drum 200 to fall into the waste chamber 121 from the first opening 140. At least three first rollers 131 are rotatably arranged at a bottom of the baffle plate 130, so as to reduce a friction between the baffle plate 130 and the base 100 to facilitate the movement of the baffle plate 130.

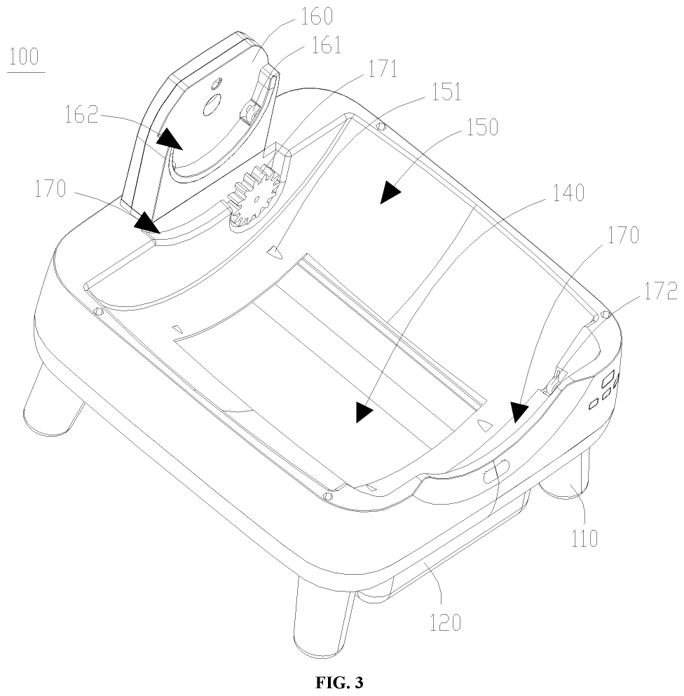

In an embodiment, referring to FIG. 3, an upper surface of the base 100 is downwards sunken to form an avoiding slot 150. The first opening 140 is located in the avoiding slot 150. The baffle plate 130 is of a structure with a downwards sunken middle portion. A bottom surface of the avoiding slot 150 is a sunken cambered surface, so that the avoiding slot 150 is matched with the rotary drum 200 in shape to provide an avoiding space for the rotation of the rotary drum 200. Moreover, the bottom surface of the avoiding slot 150 is the sunken cambered surface, which can facilitate the movement of the baffle plate 130. At the initial position, at least part of the baffle plate 130 is arranged in the avoiding slot 150. It should be understood that at the initial position, the baffle plate 130 can be fully arranged in the avoiding slot 150, or, when the baffle plate 130 is large in size, the baffle plate 130, at the initial position, can also be partially arranged in the avoiding slot 150, which can be configured according to a need.

Specifically, the avoiding slot 150 is a U-shaped slot. The first opening 140 is located at the bottommost end of the avoiding slot 150, so that after the rotary drum 200 is cleaned and reset, the baffle plate 130 will move to the first opening 140 under its own gravity to cover the first opening 140.

In an embodiment, referring to FIG. 3, the bottom surface of the avoiding slot 150 is provided with concave grooves 151 at two ends of the first opening 140 to store the first rollers 131, and the first rollers 131 are arranged in the concave grooves 151 when the baffle plate 130 is at the initial position. The concave grooves 151 are used to store the first rollers 131, which can effectively reduce a gap between the baffle plate 130 and the bottom surface of the avoiding slot 150 and alleviate the diffusion of the odor of the waste

Specifically, side walls of the concave grooves 151 are first guide surfaces, so that when the first rollers 131 roll, the first rollers leave the concave grooves 151 to prevent the concave grooves 151 from affecting the movement of the baffle plate 130. The first guide surfaces can be inclined surfaces or cambered surfaces.

In an embodiment, referring to FIG. 2, a size of the baffle plate 130 is larger than a size of the first opening 140, so that the baffle plate 130 can completely cover the first opening 140.

In an embodiment, a width of the bottom surface of the avoiding slot 150 extending on one or two sides of the first opening 140 is greater than a moving distance of the baffle plate 130, so as to prevent the first rollers 131 on the baffle plate 130 from moving out of the avoiding slot 150, causing the problem that the baffle plate 130 cannot be reset by its own gravity to affect the use effect.

In an embodiment, a quantity of the first rollers 131 is four, and the four first rollers are divided into two groups located at a front end and a rear end of the first opening 140, so as to improve the stability of movement of the baffle plate 130. Of course, there can also be three, five, or six first rollers 131. There is no limitation on the quantity of the first rollers 131 here.

In an embodiment, referring to FIG. 4, the rotary drum 200 is provided with a second opening 210 communicated with an interior of the rotary drum, and the push members 250 are located on a side edge of the second opening 210. Therefore, when the rotary drum 200 rotates and the second opening 210 moves to be opposite to the first opening 140, the push members 250 push the baffle plate 130 to move to open the first opening 140, and the waste discharged by the rotary drum 200 from the second opening 210 falls into a first bedpan via the first opening 140, so as to prevent such a phenomenon that opening the first opening 140 too early may prolong the diffusion time of the odor of the waste in the bedpan.

In an embodiment, a quantity of the push members 250 is plural. At least two of the push members 250 are located on two sides of the second opening 210, so that when the rotary drum 200 rotates in a direction opposite to a waste discharging rotating direction, the first opening 140 can also be opened through the push members 250, and pet litter inside the rotary drum 200 falls into the waste chamber 121 via the first opening 140 after being discharged from the second opening 210.

In an embodiment, continuing to refer to FIG. 4, the rotary drum 200 is internally provided with an integral partition plate 220 located next to the second opening 210 and a sifter 260 located on one side, away from the second opening 210, of the integral partition plate 220. The sifter 260 and the integral partition plate 220 divide the interior of the rotary drum 200 into a storage tank 244 for storing pet litter and a pet chamber 270. When the rotary drum 200 rotates, the pet litter and the waste are sifted through the sifter 260. When the rotary drum continues to rotate, the waste rotates along the integral partition plate 220 to the second opening 210 for discharging. An effect of automatically cleaning waste is achieved. The pet litter enters the storage tank 244 for temporary storage and is prevented from being discharged.

In an embodiment, the integral partition plate 220 and the rotary drum 200 are integrally molded to reduce production procedures and prevent the pet litter from being kept in a gap between the integral partition plate 220 and an inner wall of the rotary drum 200.

In an embodiment, to facilitate the production of the rotary drum 200, the rotary drum 200 includes a first housing 241 and a second housing 242 connected to the first housing 241. The integral partition plate 220 includes a first partition plate 221 integrally molded with the first housing 241, and a second partition plate 222 integrally molded with the second housing 242. The first partition plate 221 and the second partition plate 222 form the integral partition plate 220 when the first housing 241 is connected to the second housing 242.

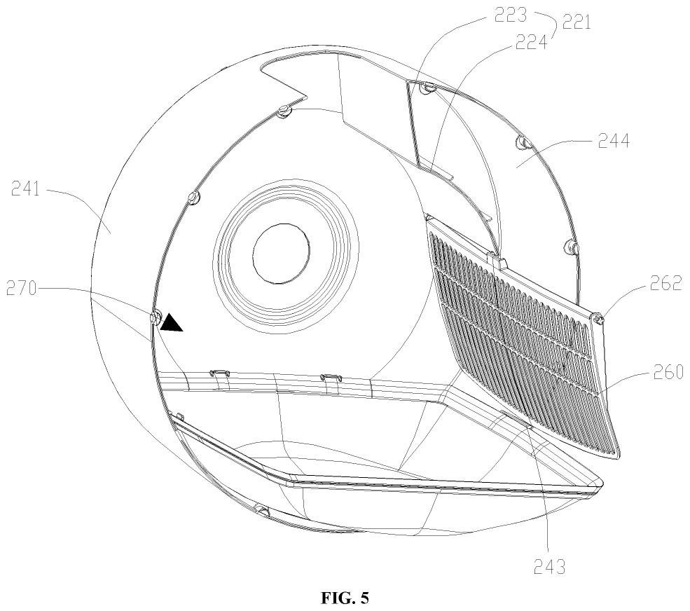

In an embodiment, referring to FIG. 5, the integral partition plate 220 includes a cambered surface section 224 located next to the sifter 260, and a guide section 223. A side surface, away from the storage tank 244, of the cambered surface section 224 is a cambered surface protruding relative to the side wall of the rotary drum 200. The guide section 223 extends from the cambered surface section 224 to the second opening 210 to guide the waste to the second opening 210 when the rotary drum 200 rotates. It should be noted that the first partition plate 221 and the second partition plate 222 each include the cambered surface section 224 and the guide section 223. A side surface, away from the storage tank 244, of the cambered surface section 224 is a cambered surface protruding relative to an inner side wall of the rotary drum 200. The guide section 223 extends from the cambered surface section 224 to the second opening 210 of the rotary drum 200. The guide section 223 may be an inclined surface or a cambered surface. In this way, when the rotary drum 200 rotates, the waste is smoothly guided to the second opening 210 through the cambered surface section 224 and the guide section 223 along the rotating direction and is directly discharged out of the rotary drum 200 via the second opening 210, which can effectively prevent the waste from being adhered to the integral partition plate 220, so as to better keep the rotary drum 200 clean.

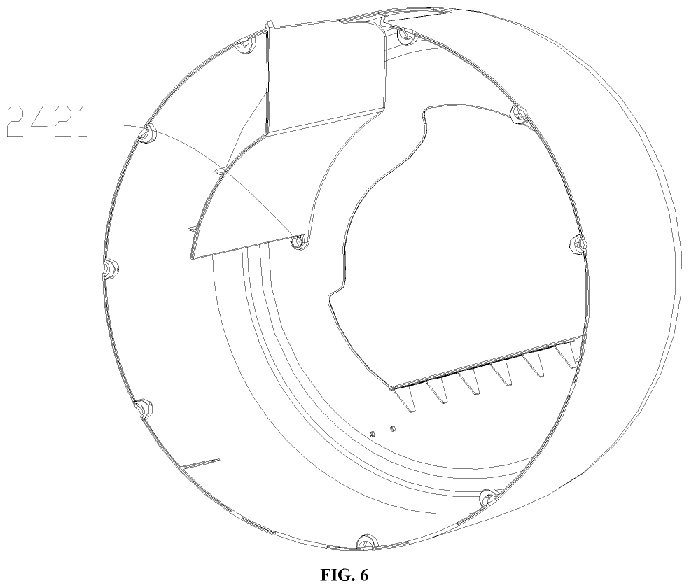

In an embodiment, referring to FIG. 5 and FIG. 6, two end surfaces of the sifter 260 protrude outwards to form first insertion blocks 262. First insertion slots 2421 are formed in positions, corresponding to the first insertion blocks 262, on the inner side wall of the rotary drum 200. The first insertion blocks 262 are arranged in the first insertion slots 2421, so as to clamp and mount the sifter 260 in the rotary drum 200. The inner side wall of the rotary drum 200 protrudes on one side, away from the integral partition plate 220, of the sifter 260 to form a first limiting block 243 for limiting the sifter 260. The sifter 260 is located between the first limiting block 243 and the integral partition plate 220. By cooperation between the first insertion blocks 262 and the first limiting block 243, the sifter 260 can be limited, so that the sifter 260 is prevented from rotating relative to the rotary drum 200 when the rotary drum 200 rotates, which affects the sifting effect on the waste and the pet litter.

In an embodiment, referring to FIG. 2 and FIG. 3, a rear end surface of the rotary drum 200 is provided with a first gear 2411. First supporting slots 170 matched with the rotary drum 200 are formed in a front side wall and a rear side wall of the avoiding slot 150. The base 100 is provided with a motor 180 and a second gear 171 connected with the motor 180. The second gear 171 is at least partially located in the first supporting slot 170 at the rear end. The second gear 171 is engaged with the first gear 2411. When the motor 180 drives the second gear 171 to rotate, the rotary drum 200 rotates through the first gear 2411. A bottom surface of the first supporting slot 170 located on the front side wall of the avoiding slot 150 is rotatably provided with a plurality of second rollers 172 spaced apart from each other. The first supporting slots 170 are used to support the front and rear ends of the rotary drum 200. Furthermore, a friction between the rotary drum 200 and the base 100 can be reduced through the second rollers 172, and the stability of rotation of the rotary drum 200 can be improved.

In an embodiment, the base 100 is provided with a support plate 160. The support plate 160 is located behind the first supporting slot 170 located at the rear end. A second supporting slot 162 is formed in the support plate 160. A bottom surface of the second supporting slot 162 is rotatably provided with a plurality of third rollers 161 spaced apart from each other. A convex column 2412 is arranged on the rear end surface of the rotary drum 200. The convex column 2412 is located in the middle of the first gear 2411. An annular groove 2413 is formed in an outer side wall of the convex column 2412. Some of the third rollers 161 are arranged in the annular groove 2413. Due to cooperation between the third rollers 161 and the annular groove 2413, the stability of rotation of the rotary drum 200 can be further improved.

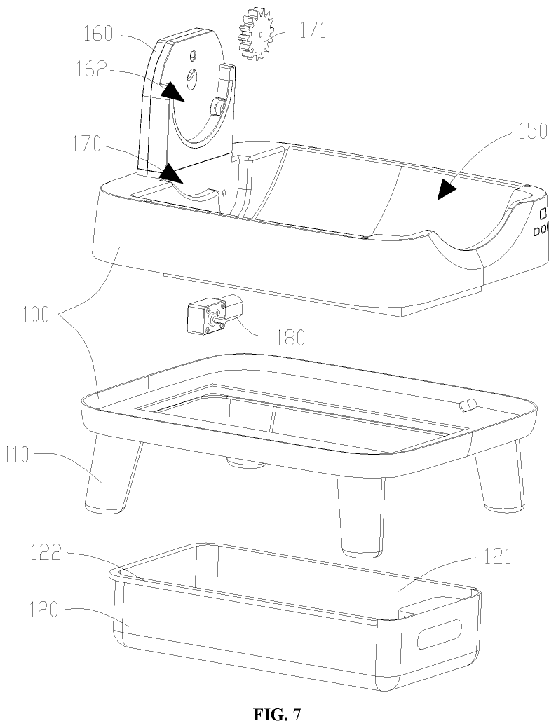

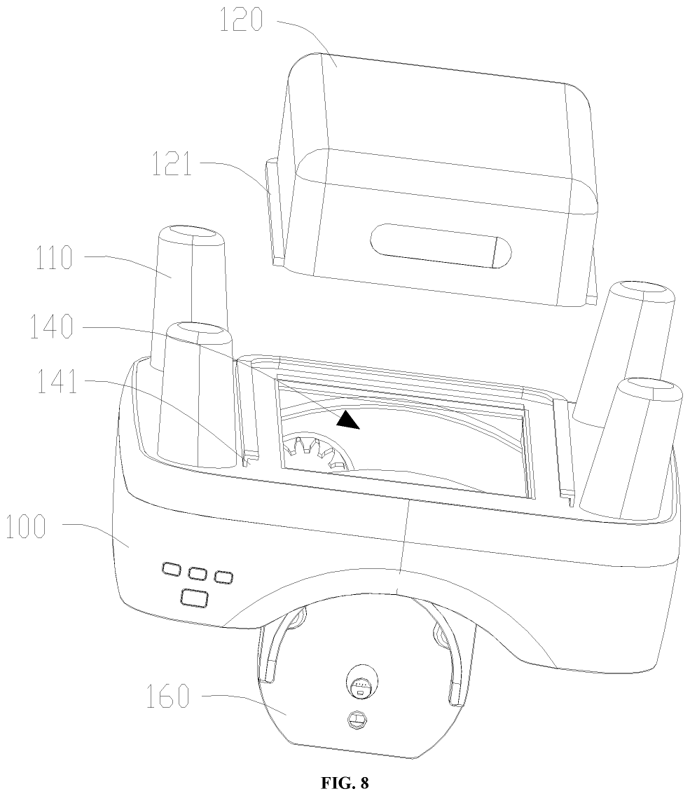

In an embodiment, referring to FIG. 7 and FIG. 8, a bottom of the base 100 is detachably provided with a collection basin 120, and the waste chamber 121 is located on the collection basin 120. It is convenient to remove the collection basin 120, and a user can regularly clean waste of a pet conveniently. Of course, in other embodiments, the waste chamber can also be formed inside the base 100, and is used in cooperation with the first opening 140 to also store the waste of the pet.

In an embodiment, two sides of a top of the collection basin 120 outwards extend to form second insertion blocks 122. Sliding chutes 141 used in conjunction with the second insertion blocks 122 are formed in the bottom of the base 100. It should be understood that the sliding chutes 141 are located on two sides of the first opening 140. The second insertion blocks 122 are arranged in the sliding chutes 141, so that the collection basin 120 is mounted at the bottom of the base 100. Furthermore, when it is necessary to remove the collection basin 120, the collection basin 120 can be pulled out to facilitate use. In other embodiments, the collection basin 120 can also be removed by using buckles, hasps, or drawers.

In an embodiment, the bottom of the base 100 is further provided with a plurality of support legs 110 located on a circumferential side of the collection basin 120. A bottom surface of the collection basin 120 is located above bottom surfaces of the support legs 110, which can suspend the collection basin 120, reduce friction and scratches between the collection basin 120 and a placement plane of the pet toilet in this embodiment, and facilitate the removal of the collection basin.

It should be noted that all directional indications (such as up, down, left, right, front, back . . . ) in the embodiments of the present disclosure are only used to explain a relative positional relationship between components, motion situations, etc. at a certain specific attitude (as shown in the figures). If the specific attitude changes, the directional indication also correspondingly changes.

In addition, the descriptions of “first”, “second”, etc. in the present disclosure are only used for descriptive purposes, and cannot be understood as indicating or implying its relative importance or implicitly indicating the number of technical features indicated. Therefore, features defined by “first” and “second” can explicitly instruct or impliedly include at least one feature. In addition, “and/or” in the entire text includes three solutions. A and/or B is taken as an example, including technical solution A, technical solution B, and technical solutions that both A and B satisfy. In addition, the technical solutions between the various embodiments can be combined with each other, but it needs be based on what can be achieved by those of ordinary skill in the art. When the combination of the technical solutions is contradictory or cannot be achieved, it should be considered that such a combination of the technical solutions does not exist, and is not within the scope of protection claimed by the present disclosure.

The above descriptions are only preferred embodiments of the present disclosure, and are not intended to limit the patent scope of the present disclosure. Any equivalent structural transformation made by using the content of the specification and the drawings of the present disclosure under the invention idea of the present disclosure, directly or indirectly applied to other related technical fields, shall all be included in the scope of patent protection of the present disclosure.

What is claimed is:

1. A pet toilet, comprising a base, and a rotary drum rotatably arranged on the base, wherein the base is provided with a waste chamber for collecting waste and a first opening communicated with the waste chamber; the base is movably provided with a baffle plate at the first opening;
at an initial position, the baffle plate covers the first opening; and in a rotating process of the rotary drum, the baffle plate moves with the rotary drum to open the first opening.

2. The pet toilet according to claim 1, wherein the rotary drum is provided with a number of push members; at least three first rollers are rotatably arranged at a bottom of the baffle plate; and in the rotating process of the rotary drum, the push members push the baffle plate to move to open the first opening.

3. The pet toilet according to claim 2, wherein an upper surface of the base is downwards sunken to form an avoiding slot; a bottom surface of the avoiding slot is a sunken cambered surface; the first opening is located in the avoiding slot; at the initial position, at least part of the baffle plate is arranged in the avoiding slot; and the baffle plate is of a structure with a downwards sunken middle portion.

4. The pet toilet according to claim 3, wherein the bottom surface of the avoiding slot is provided with concave grooves at two ends of the first opening to store the first rollers, and the first rollers are arranged in the concave grooves when the baffle plate is at the initial position.

5. The pet toilet according to claim 4, wherein a side wall of each concave groove is a first guide surface.

6. The pet toilet according to claim 4, wherein a size of the baffle plate is greater than a size of the first opening.

7. The pet toilet according to claim 3, wherein a width of the bottom surface of the avoiding slot extending on one or two sides of the first opening is greater than a moving distance of the baffle plate.

8. The pet toilet according to claim 2, wherein a quantity of the first rollers is four, and the four first rollers are divided into two groups located at a front end and a rear end of the first opening.

9. The pet toilet according to claim 2, wherein the rotary drum is provided with a second opening communicated with an interior of the rotary drum, and the push members are located on a side edge of the second opening.

10. The pet toilet according to claim 9, wherein a quantity of the push members is plural, and at least two of the push members are located on two sides of the second opening.

11. The pet toilet according to claim 2, wherein the rotary drum is internally provided with an integral partition plate located next to the second opening and a sifter located on one side, away from the second opening, of the integral partition plate; the sifter and the integral partition plate divide the interior of the rotary drum into a storage tank for storing pet litter and a pet chamber; when the rotary drum rotates, pet litter and waste are sifted through the sifter; and when the rotary drum continues to rotate, the waste rotates along the integral partition plate to the second opening for discharging.

12. The pet toilet according to claim 11, wherein the integral partition plate and the rotary drum are integrally molded.

13. The pet toilet according to claim 12, wherein the rotary drum comprises a first housing and a second housing connected to the first housing; the integral partition plate comprises a first partition plate integrally molded with the first housing, and a second partition plate integrally molded with the second housing; and the first partition plate and the second partition plate form the integral partition plate when the first housing is connected to the second housing.

14. The pet toilet according to claim 13, wherein the integral partition plate comprises a cambered surface section located next to the sifter, and a guide section; a side surface, away from the storage tank, of the cambered surface section is a cambered surface protruding relative to a side wall of a bin body; and the guide section extends from the cambered surface section to the second opening to guide the waste to the second opening when the rotary drum rotates.

15. The cat litter bin according to claim 14, wherein two end surfaces of the sifter protrude outwards to form first insertion blocks; first insertion slots are formed in positions, corresponding to the first insertion blocks, on an inner side wall of the rotary drum; the first insertion blocks are arranged in the first insertion slots; the inner side wall of the rotary drum protrudes on one side, away from the integral partition plate, of the sifter to form a first limiting block for limiting the sifter.

16. The pet toilet according to claim 3, wherein a rear end surface of the rotary drum is provided with a first gear; first supporting slots matched with the rotary drum are formed in a front side wall and a rear side wall of the avoiding slot; the base is provided with a motor and a second gear connected with the motor; the second gear is at least partially located in the first supporting slot at the rear end; the second gear is engaged with the first gear; when the motor drives the second gear to rotate, the rotary drum rotates through the first gear; and a bottom surface of the first supporting slot located on the front side wall of the avoiding slot is rotatably provided with a plurality of second rollers spaced apart from each other.

17. The pet toilet according to claim 16, wherein the base is provided with a support plate; the support plate is located behind the first supporting slot located at the rear end; a second supporting slot is formed in the support plate; a bottom surface of the second supporting slot is rotatably provided with a plurality of third rollers spaced apart from each other; a convex column is arranged on the rear end surface of the rotary drum; the convex column is located in the middle of the first gear; an annular groove is formed in an outer side wall of the convex column; and some of the third rollers are arranged in the annular groove.

18. The pet toilet according to claim 3, wherein a bottom of the base is detachably provided with a collection basin, and the waste chamber is located on the collection basin.

19. The pet toilet according to claim 18, wherein two sides of a top of the collection basin outwards extend to form second insertion blocks; sliding chutes used in conjunction with the second insertion blocks are formed in the bottom of the base; and the second insertion blocks are arranged in the sliding chutes.

20. The pet toilet according to claim 19, wherein the bottom of the base is further provided with a plurality of support legs located on a circumferential side of the collection basin; and a bottom surface of the collection basin is located above bottom surfaces of the support legs.
